(19) United States
(12) Patent Application Publication
(10) Pub. No.: US 2026/0313521 A1
(43) Pub. Date: Oct. 8, 2026

(54) Channel Access Procedures for User Equipment

(71) Applicant: Apple Inc., Cupertino, CA (US)

(72) Inventors: Xiang CHEN, Palo Alto, CA (US); Dawei ZHANG, Saratoga, CA (US); Haitong SUN, Saratoga, CA (US); Jie CUI, San Jose, CA (US); Qiming LI, Beijing (CN); Rolando E BETTANCOURT ORTEGA, Munich (DE); Yang TANG, San Jose, CA (US)

(21) Appl. No.: 19/482,427

(22) PCT Filed: May 9, 2023
(86) PCT No.: PCT/CN2023/093070

§ 371 Date: Nov. 7, 2025

(51) Int. Cl. H04W 48/10; H04W 48/20

(52) U.S. Cl. CPC H04W 48/10; H04W 48/20

(57) ABSTRACT

A user equipment (UE) configured to receive, from a target cell, a cell identification (ID) number and determine the cell ID number is in one of a first range of values or a second range of values, wherein the first range of values indicates a channel being served by the target cell is a first type of channel and the second range of values indicates the channel being served by the target cell is a second type of channel.

### TECHNICAL FIELD

The present disclosure generally relates to wireless communication, and in particular, to channel access procedures for user equipment.

### BACKGROUND

Harmonious management of legacy user equipment (UEs) and new UEs is a complex and evolving field. As cellular standards evolve, it is critical that new features of the cellular protocol do not negatively impact legacy UEs. Recent evolution of the 5G New Radio (NR) standards involve the implementation of 3 MHz channels, as well as 5 MHz channels with new Physical Broadcast Channel (PBCH) designs. Legacy UEs are not equipped to camp on cells serving less than 5 MHz channels. A manner of preventing legacy UEs from camping on such cells is needed.

### SUMMARY

Some exemplary embodiments are related to a method performed by a user equipment (UE). The method includes receiving, from a target cell, a cell identification (ID) number and determining the cell ID number is in one of a first range of values or a second range of values, wherein the first range of values indicates a channel being served by the target cell is a first type of channel and the second range of values indicates the channel being served by the target cell is a second type of channel.

Other exemplary embodiments are related to a method performed by a base station. The method includes broadcasting a cell identification (ID) number, wherein the cell ID number is in one of a first range of values or a second range of values, wherein the first range of values indicates a channel being served by the base station is a first type of channel and the second range of values indicates the channel being served by the base station is a second type of channel and when a user equipment (UE) supports the first type and the second type of channel, permitting an access attempt by the UE.

Still further exemplary embodiments are related to a method performed by a user equipment (UE). The method includes receiving a master information block (MIB) from a target cell, decoding the MIB, determining, based on information in the MIB, a channel served by the target cell is barred and determining, based on further information in the MIB, that the UE is not barred from using the channel.

Other exemplary embodiments are related to a method performed by a base station. The method includes encoding a master information block (MIB) for a channel served by the base station, the MIB comprising a value of a first information element (IE) indicating a first type of user equipment (UE) is barred from accessing the channel, the MIB further comprising a value of a second IE indicating a second type of UE can access the channel and broadcasting the MIB.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows an enhanced Master Information Block (MIB), according to various exemplary embodiments.

FIG. 5 shows a first method diagram, according to various exemplary embodiments.

FIG. 6 shows a second method diagram, according to various exemplary embodiments.

### DETAILED DESCRIPTION

The exemplary embodiments may be further understood with reference to the following description and the related appended drawings, wherein like elements are provided with the same reference numerals. The exemplary embodiments relate to enhanced cell search differentiation procedures for legacy and new UEs.

The exemplary embodiments are described with regard to a UE. However, reference to a UE is merely provided for illustrative purposes. The exemplary embodiments may be utilized with any electronic component that may establish a connection to an accessory device and is configured with the hardware, software, and/or firmware to exchange information and data with accessory devices. Therefore, the UE as described herein is used to represent any electronic component.

The exemplary embodiments are also described with reference to a 5G New Radio (NR) network. However, it should be understood that the exemplary embodiments may also be implemented in other types of networks, including but not limited to LTE networks, future evolutions of the cellular protocol (e.g., 6G), or any other type of network.

Sub-5 MHz channels introduced in recent evolutions of the cellular protocols may be applicable to legacy bands, in which legacy UEs operate. Numerous issues are presented by such a scenario. Legacy UEs may attempt to decode synchronization signal blocks (SSBs) to receive a Master Information Block (MIB) relevant to the determination of whether a legacy UE may camp on a particular cell. Preventing such behavior is desirable to prevent wasted legacy UE signaling and power use in fruitless attempts to use sub-5 MHz channels.

While modification of the synchronization raster for new channel designs (and new UEs that support new channel designs) is possible, there are several issues with such an approach. The first is that the total number of raster points increases for future UEs that support such an implementation (as well as legacy implementations). Another issue is that due to narrow frequency separation between any two adjacent raster points, a UE may not be able to accurately differentiate which raster point it is decoding a Physical Broadcast Channel (PBCH) due to initial local oscillator frequency inaccuracy.

Proposed punctured PBCH designs may cause undesirable behavior with legacy UEs attempting to access cells utilizing new channel designs. Specifically, a legacy UE may still be capable of decoding a new-design PBCH and continue to receive a system information block (SIB) 1 to obtain the information element (IE) carrierBandwidth. The legacy UE will then determine that it cannot access the channel, wasting both time and energy. It is desirable to stop the cell selection attempt of a legacy UE as soon as possible to reduce legacy UE power and signaling.

One of skill in the art will recognize that the existing physical cell ID (PCI) range is [0-1007], allowing for 1008 possible PCIs. According to some exemplary embodiments, extending the PCI range (e.g., [1008-2015]) will allow legacy UEs to determine that Primary Synchronization Signal (PSS) and Secondary Synchronization Signal (SSS) detection operations are unsuccessful. A legacy UE would be aware that any PCI beyond 1007 is not a cell that the legacy UE can access. Such a determination would cause a legacy UE to move on to a next raster point (e.g., the legacy UE will not access the new channel).

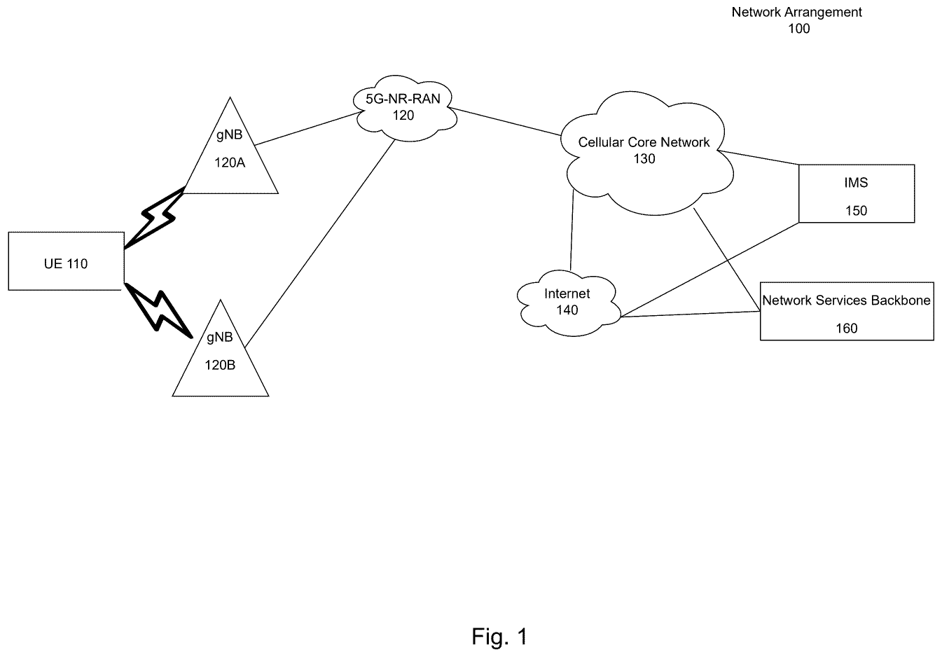

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of one UE 110 is merely provided for illustrative purposes.

The UE 110 may be configured to communicate with one or more networks. In the example of the network arrangement 100, the network with which the UE 110 may wirelessly communicate is a 5G NR radio access network (RAN) 120. However, it should be understood that the UE 110 may also communicate with other types of networks (e.g., 5G cloud RAN, a next generation PAN (NG-RAN), a legacy cellular network, etc.) and the UE 110 may also communicate with networks over a wired connection. With regard to the exemplary embodiments, the UE 110 may establish a connection with the 5G NR PAN 120. Therefore, the UE 110 may have a 5G NR chipset to communicate with the NR PAN 120.

The 5G NR PAN 120 may be portions of a cellular network that may be deployed by a network carrier (e.g., Verizon, AT&T, T-Mobile, etc.). The PAN 120 may include cells or base stations that are configured to send and receive traffic from UEs that are equipped with the appropriate cellular chip set. In this example, the 5G NR PAN 120 includes the gNB 120A. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Those skilled in the art will understand that any association procedure may be performed for the UE 110 to connect to the 5G NR PAN 120. For example, as discussed above, the 5G NR PAN 120 may be associated with a particular network carrier where the UE 110 and/or the user thereof has a contract and credential information (e.g., stored on a SIM card). Upon detecting the presence of the 5G NR PAN 120, the UE 110 may transmit the corresponding credential information to associate with the 5G NR PAN 120. More specifically, the UE 110 may associate with a specific cell (e.g., gNB 120A). There may also be one or more neighboring cells with which the UE may communicate with prior to a handover operation. One additional neighbor cell is shown in FIG. 1 with gNB 120B, but one of skill in the art will recognize that a UE may have more than one neighbor cell available for handover. The gNB 120B may have differing channel designs than the gNB 120A.

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

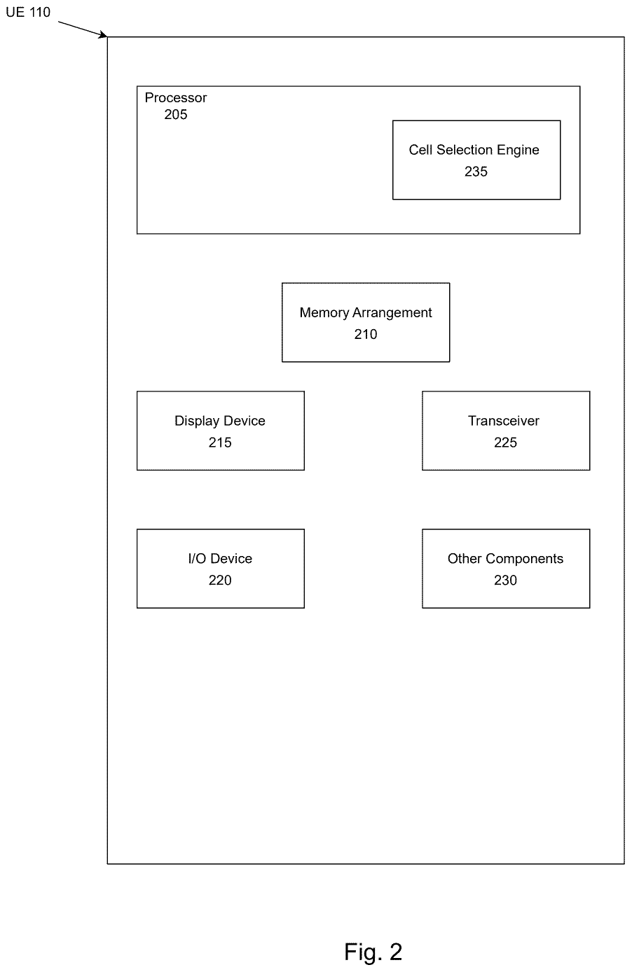

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include a cell selection engine 235 for performing operations related to determining whether the UE 110 will continue a cell selection procedure with a target cell utilizing a new channel design.

The above referenced engine being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR PAN 120. Accordingly, the transceiver 225 may operate on a variety of different frequencies or channels (e.g., set of consecutive frequencies).

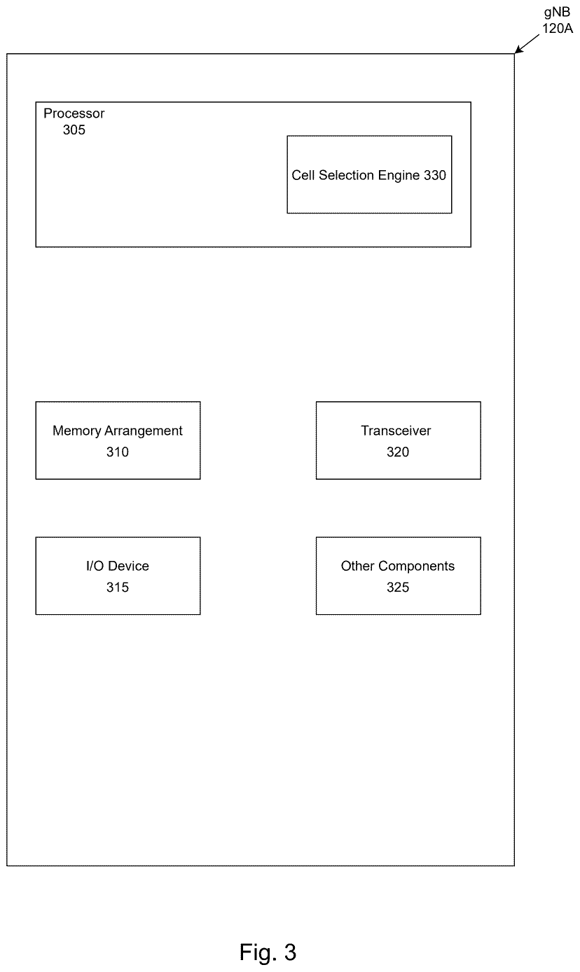

FIG. 3 shows an exemplary base station 300 according to various exemplary embodiments. The base station 300 may represent the gNB 120A (or the gNB 120B) or any other access node through which the UE 110 may establish a connection and manage network operations.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the UE 110. For example, the engines may include a cell selection engine 330 for performing operations related to transmission of information that the UE 110 will use to determine whether to continue a cell selection procedure with a target cell utilizing a new channel design.

The memory arrangement 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

In a first aspect of the exemplary embodiments, an enhanced PCI range for new channel designs is disclosed. In the first aspect, the PCI range is extended from [0-1007] to include [1008-2015]. Shown below is Equation 1, which may be utilized to generate an extended PCI space beyond existing implementations.

$${N}_{ID}^{cell} = 6 {N}_{ID}^{( 1 )} + {N}_{ID}^{( 2 )} \qquad Equation 1$$

$$where {N}_{ID}^{( 1 )} ∈ \{ 0 , 1 , ... , 335 \} and {N}_{ID}^{( 2 )} ∈ \{ 0 , 1 , 2 , 3 , 4 , 5 \}$$

One of skill in the art will recognize that

$${N}_{ID}^{( 2 )}$$

is used for PSS sequence generation and both

$${N}_{ID}^{( 1 )} and {N}_{ID}^{( 2 )}$$

are used in SSS generation.

Expansion of the PCI space may also be enhanced by way of three alternatives. In a first alternative,

$${N}_{ID}^{( 1 )}$$

may become a value from [336-671] during SSS generation. In a second alternative, both

$${N}_{ID}^{( 1 )} and {N}_{ID}^{( 2 )}$$

may be modified to give a PCI range of [1008-2015]. In a third alternative, the range of a PCI may differ from [1008-2015] or may not provide the same number of unique cell IDs of 1008.

In a second aspect of the exemplary embodiments, six possible sequences of length-127 may be used for PSS generation in equation 2, disclosed below:

$$m = ( n + P ) mod 127 \qquad Equation 2$$

$$P = 0 , for {N}_{ID}^{( 2 )} = 0$$

$$P = 43 , for {N}_{ID}^{( 2 )} = 1$$

$$P = 86 , for {N}_{ID}^{( 2 )} = 2$$

$$P = 21 or 22 , for {N}_{ID}^{( 2 )} = 3$$

$$P = 64 or 65 , for {N}_{ID}^{( 2 )} = 4$$

$$P = 106 or 107 , for {N}_{ID}^{( 2 )} = 5$$

In a third aspect of the exemplary embodiments, an enhanced SSS sequence generation is disclosed. In the third aspect,

$${N}_{ID}^{( 2 )}$$

may range from {0, 1, 2, 3, 4, 5}. Equation 3 shows an enhanced means of SSS generation for cell search differentiation between legacy and new UEs in sub-5 MHz channels.

$${m}_{0} = 15 ⌊ \frac{{N}_{ID}^{( 1 )}}{112} ⌋ + 5 \{ {N}_{ID}^{( 2 )} mod 3 \} + 45 ⌊ \frac{{N}_{ID}^{( 2 )}}{3} ⌋ \qquad Equation 3$$

It should be understood that the above values for the first through the third aspects are only exemplary. One of skill in the art will understand that if the PCI is expanded in a different manner, e.g., not [1008-2015], the values described for the second and third aspects may also be different. However, since the manner of deriving these values have been described herein, e.g., equations 1-3, one skilled in the art will understand how to modify the parameters and/or parameter values of equations to obtain different values.

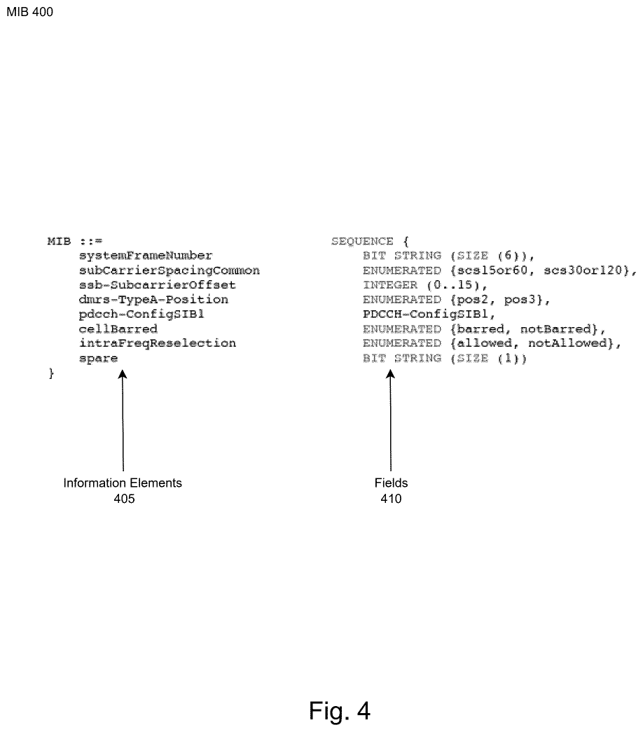

In a fourth aspect of the exemplary embodiments, enhanced MIB operations for legacy UEs are disclosed herein. FIG. 4 shows an enhanced Master Information Block (MIB) 400, according to various exemplary embodiments. The MIB 400 may be applicable to scenarios in which a legacy UE is attempting to access a cell utilizing new channel sizes (e.g., sub-5 MHz). The MIB 400 may also be applicable to scenarios in which a new UE is attempting to access a cell utilizing a new channel design.

Following initial synchronization procedures of a UE (e.g., the UE 110) with a network, the UE 110 will begin to receive information blocks from the network. One information block that the UE 110 will receive from the network is the MIB 400. The MIB 400 may contain Information Elements (IEs) 405 related to cell selection (e.g., system frame number, subcarrier spacing, subcarrier offset, etc.) Each information element of IEs 405 may have a corresponding field 410. For example, systemFrameNumber corresponds with “Bit String (Size (6))”.

One of skill in the art will recognize that each IE 405 and its corresponding field 410 have a defined bit sequence size. The MIB 400 has 24 bits available, of which 23 bits are used. This leaves an additional bit for an IE, which is labeled in the MIB 400 as “spare” and will be discussed below.

The “barred” value may be indicated for the cellBarred IE. In the scenario that a legacy UE successfully decodes PBCH MIB information, the legacy UE will know that the cell is barred from access. In a similar manner, “notbarred” may be used to indicate to both new UEs and legacy UEs that the cell is accessible (along with corresponding new channels).

Consequently, the new channel is accessible only to new UEs, and not legacy UEs. When a new UE decodes “barred”, however, the new UE may actually support the channel of the target cell. In such a case, a new UE may continue after decoding “barred” and decode the “spare” IE of the MIB 400. The “spare” IE has a single bit value that may be used to indicate to new UEs that they may continue their cell selection procedure.

It should be understood that the term “spare” for the IE containing the “extra” bit is only exemplary and may change with future evolutions of cellular standards. It should also be understood that there is no particular value that the “spare” IE needs to take for a UE capable of accessing a new channel design of a target to continue the cell selection procedure. In other words, operator implementation can dictate whether 1 or 0 in the “spare” IE field causes new UEs to continue the cell selection procedure.

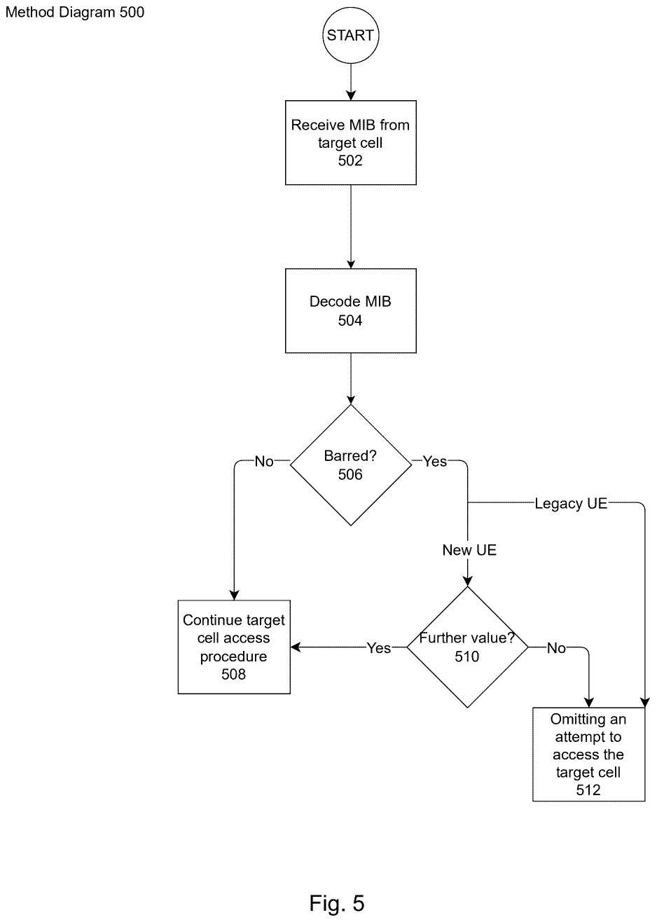

FIG. 5 shows a first method diagram 500 according to various exemplary embodiments. The method diagram 500 may be understood to incorporate the MIB 400 shown in FIG. 4. The method diagram 500 may be understood to be applicable to scenarios wherein a UE (e.g., the UE 110) is attempting to access a target cell (e.g., the gNB 120B) utilizing a new channel design (e.g., sub-5 MHz). It should be understood that the UE 110 may be camped on a first cell (e.g., the gNB 120A) and is considering whether to switch to a new target cell (e.g., the gNB 120B).

In 502, the UE 110 receives a Master Information Block (e.g., the MIB 400) from the gNB 120B (the target cell). In 504, the UE 110 decodes the MIB. In 506, the UE 110 determines the presence of “barred” in the cellBarred IE contained in the MIB 400. If “barred” is not present, the UE 110 continues to 508. In 508, the UE 110 continues the cell access procedure with the gNB 120B.

If the UE 110 determines that “barred” is present in the cellBarred IE contained in the MIB 400, the UE 110 continues to 510. It should be noted that if UE 110 is a legacy UE, the UE 110 would cease the selection procedure if the answer to 506 is yes and would proceed to 512 and omit an attempt to access the gNB 120B. Omitting the attempt to access the gNB 120B after determining the cell is barred saves energy and time at the legacy UE 110, because the legacy UE 110 will not continue along an ultimately fruitless cell selection attempt of the gNB 120B utilizing a new channel design.

In 510, if the UE 110 is a new UE capable of accessing the new channel design offered by the gNB 120B, the UE 110 determines the presence of an additional value in the “spare” bit of the MIB 400. Again, it should be understood that the particular value of the spare bit may be left to operator implementation or may be defined by standard (e.g., 3GPP standards). If the further value for the “spare” IE is present, the UE 110 proceeds to 508 and continues the gNB 120B access procedure. In this example, present means that the gNB 120B has included the “barred” indication to prevent legacy UEs from attempting to access channels that the legacy UEs are not capable of using. However, the present indication indicates to new UEs that the “barred” indication was for this reason and that since new UEs have the capability of accessing the channels that are less than 5 MHz, the new UEs may proceed. In contrast, if the further value is not present, this would signal to the new UE that the “barred” indication was for some other reason and both the legacy UEs and the new UEs are barred from accessing this cell. That operation where the new UE is also barred from accessing the cell is described below.

If the further value is not present, the UE 110 proceeds to 512. In 512, the UE 110 omits the attempt to access the gNB 120B. As described above, the operation 512 represents a scenario in which the UE 110 supports a new channel design of the gNB 120B but is still not allowed to access the cell.

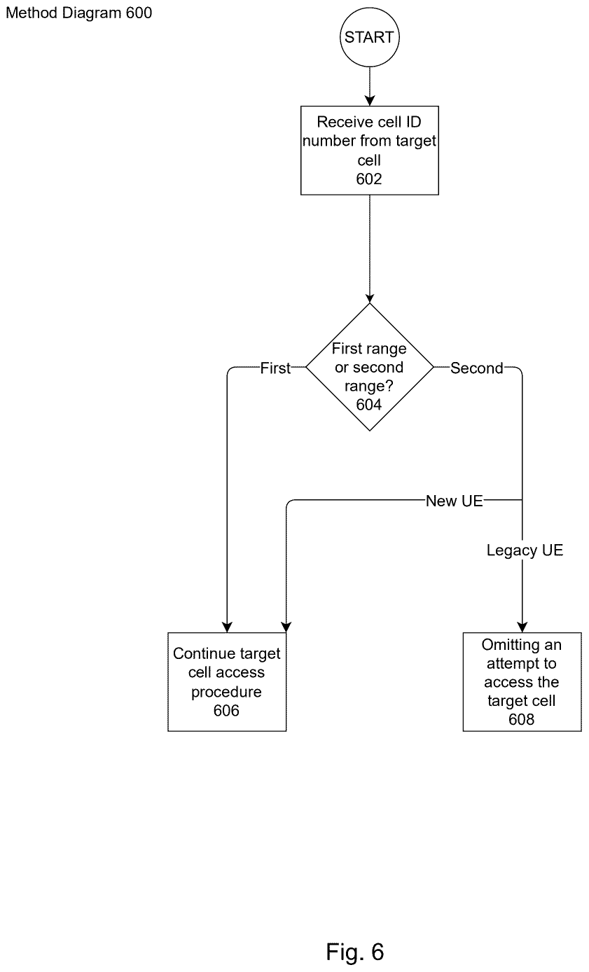

FIG. 6 shows a second method diagram 600 according to various exemplary embodiments. The method diagram 600 may be understood to be applicable to scenarios wherein a UE (e.g., the UE 110) is attempting to access a cell utilizing a new channel design (e.g., sub-5 MHz). It should be understood that the UE 110 may be camped on a first cell (e.g., gNB 120A) and is considering whether to switch to a new target cell (e.g., gNB 120B).

In 602, the UE 110 receives a physical layer cell identity (PCI) from the gNB 120B. In 604, the UE 110 determines whether the PCI is within a first range or a second range of values. The first range of values may be understood to be the existing PCI values [0-1007], and the second range of values may be understood to be the proposed expanded range of PCI values [1008-2015], though any ordinal relationship for the values is arbitrary (either range can be “first” or “second”). The method diagram 600 is described with respect to the legacy PCI range of [0-1007] being the “first” range.

If the UE 110 determines that the received PCI is in the first range, the UE 110 proceeds to 606 and continues target cell access procedures with the gNB 120B.

If the UE 110 determines that the received PCI is in the second range and if the UE 110 is a new UE capable of supporting the channel design of the gNB 120B, the UE 110 will continue to 606 and continues target cell access procedures with the gNB 120B.

If the UE 110 determines that the received PCI is in the second range, and the UE 110 is a legacy UE, the UE 110 will continue to 608 and omit an attempt to access the gNB 120B, e.g., the legacy UE will not attempt to access the cell because the UE does not support channels of less than 5 MHz.

### Examples

In a first example, a processor of a user equipment (UE) is configured to receive, from a target cell, a cell identification (ID) number and determine the cell ID number is in one of a first range of values or a second range of values, wherein the first range of values indicates a channel being served by the target cell is a first type of channel and the second range of values indicates the channel being served by the target cell is a second type of channel.

In a second example, the processor of the first example, further configured to determine the UE only supports the first type of channel, when the cell ID number is in the second range of values, omit an attempt to access the target cell.

In a third example, the processor of the first example, further configured to determine the UE supports the first type and the second type of channel and attempt to access the target cell.

In a fourth example, a user equipment (UE) comprising a transceiver to communicate with a network and the processor of any of the first through third examples communicatively coupled to the transceiver.

In a fifth example, a processor of a base station is configured to broadcast a cell identification (ID) number, wherein the cell ID number is in one of a first range of values or a second range of values, wherein the first range of values indicates a channel being served by the base station is a first type of channel and the second range of values indicates the channel being served by the base station is a second type of channel and when a user equipment (UE) supports the first type and the second type of channel, permit an access attempt by the UE.

In a sixth example, the processor of the fifth example, wherein the cell ID number is generated using

$${N}_{ID}^{cell} = 6 {N}_{ID}^{( 1 )} + {N}_{ID}^{( 2 )} ,$$

where

$${N}_{ID}^{( 1 )} ∈ \{ 0 , 1 , ... , 335 \} and {N}_{ID}^{( 2 )} ∈ \{ 0 , 1 , 2 , 3 , 4 , 5 \} .$$

In a seventh example, the processor of the fifth example, wherein the cell ID number is generated using

$${N}_{ID}^{cell} = 6 {N}_{ID}^{( 1 )} + {N}_{ID}^{( 2 )} ,$$

where and

$${N}_{ID}^{( 1 )} ∈ \{ 336 , 337 , ... , 671 \} and {N}_{ID}^{( 2 )} ∈ \{ 0 , 1 , 2 \} .$$

In an eighth example, the processor of the fifth example, wherein the first type of channel is greater than or equal to 5 MHz.

In a ninth example, the processor of the fifth example, wherein the second type of channel is less than 5 MHz.

In a tenth example, a base station comprising a transceiver to communicate with a user equipment (UE) and the processor of any of the fifth through ninth examples communicatively coupled to the transceiver.

In an eleventh example, a processor of a user equipment (UE) configured to receive a master information block (MIB) from a target cell, decode the MIB, determine, based on information in the MIB, a channel served by the target cell is barred and determine, based on further information in the MIB, that the UE is not barred from using the channel.

In a twelfth example, the processor of the eleventh example, wherein the information comprises a value of a cellBarred information element (IE) of the MIB.

In a thirteenth example, the processor of the eleventh example, wherein the further information comprises a value of an information element (IE) in the MIB that is not a cellBarred IE.

In a fourteenth example, the processor of the eleventh example, wherein the channel comprises a bandwidth less than 5 MHz.

In a fifteenth example, a user equipment (UE) comprising a transceiver to communicate with a network and the processor of any of the eleventh through fourteenth examples communicatively coupled to the transceiver.

In a sixteenth example, a processor of a base station configured to encode a master information block (MIB) for a channel served by the base station, the MIB comprising a value of a first information element (IE) indicating a first type of user equipment (UE) is barred from accessing the channel, the MIB further comprising a value of a second IE indicating a second type of UE can access the channel and broadcast the MIB.

In a seventeenth example, the processor of the sixteenth example, wherein the first type of UE does not support channels having a bandwidth less than 5 MHz.

In an eighteenth example, the processor of the sixteenth example, wherein the second type of UE supports channels having a bandwidth less than 5 MHz.

In a nineteenth example, the processor of the sixteenth example, wherein the channel has a bandwidth less than 5 MHz.

In a twentieth example, the processor of the sixteenth example, wherein the first IE comprises a cellBarred IE.

In a twenty first example, the processor of the sixteenth example, wherein the second IE comprises a single bit value.

In a twenty second example, a base station comprising a transceiver to communicate with a user equipment (UE) and the processor of any of the sixteenth through twenty first examples communicatively coupled to the transceiver.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. (canceled)

2. (canceled)

3. (canceled)

4. A method performed by a base station, comprising:
broadcasting a cell identification (ID) number, wherein the cell ID number is in one of a first range of values or a second range of values, wherein the first range of values indicates a channel being served by the base station is a first type of channel and the second range of values indicates the channel being served by the base station is a second type of channel; and
when a user equipment (UE) supports the first type and the second type of channel, permitting an access attempt by the UE.

5. The method of claim 4, wherein the cell ID number is generated using N_ID\hat{ }cell= [symbol] 6N [symbol] _ID\hat{ }((1))+N_ID\hat{ }((2)), where N_ID\hat{ }((1))∈E{0, 1, . . . , 335} and N_ID\hat{ }((2))∈{0,1,2,3,4,5}.

6. The method of claim 4, wherein the cell ID number is generated using N_ID\hat{ }cell= [symbol] 6N [symbol] _ID\hat{ }((1))+N_ID\hat{ }((2)), where N_ID\hat{ }((1))∈{336,337, . . . , 671} and N_ID\hat{ }((2))∈{0,1,2}.

7. The method of claim 4, wherein the first type of channel is greater than or equal to 5 MHz.

8. The method of claim 4, wherein the second type of channel is less than 5 MHz.

9. A method performed by a user equipment (UE), comprising:
receiving a master information block (MIB) from a target cell;
decoding the MIB;
determining, based on information in the MIB, a channel served by the target cell is barred; and
determining, based on further information in the MIB, that the UE is not barred from using the channel.

10. The method of claim 9, wherein the information comprises a value of a cellBarred information element (IE) of the MIB.

11. The method of claim 9, wherein the further information comprises a value of an information element (IE) in the MIB that is not a cellBarred IE.

12. The method of claim 9, wherein the channel comprises a bandwidth less than 5 MHz.

13. A method performed by a base station, comprising:
encoding a master information block (MIB) for a channel served by the base station, the MIB comprising a value of a first information element (IE) indicating a first type of user equipment (UE) is barred from accessing the channel, the MIB further comprising a value of a second IE indicating a second type of UE can access the channel; and
broadcasting the MIB.

14. The method of claim 13, wherein the first type of UE does not support channels having a bandwidth less than 5 MHz.

15. The method of claim 13, wherein the second type of UE supports channels having a bandwidth less than 5 MHz.

16. The method of claim 13, wherein the channel has a bandwidth less than 5 MHz.

17. The method of claim 13, wherein the first IE comprises a cellBarred IE.

18. The method of claim 13, wherein the second IE comprises a single bit value.
